(19) United States
(12) Patent Application Publication
(10) Pub. No.: US 2015/0097378 A1
(43) Pub. Date: Apr. 9, 2015

(54) MOTOR VEHICLE LOCK

(71) Applicants: Ludger Graute, Essen (DE); Thomas Kippes, Meerbusch (DE)

(72) Inventors: Ludger Graute, Essen (DE); Thomas Kippes, Meerbusch (DE)

(21) Appl. No.: 13/982,308

(22) PCT Filed: Jan. 12, 2012
(86) PCT No.: PCT/DE2012/000021

§ 371 Date: Jul. 31, 2014

(30) Foreign Application Priority Data
Jan. 28, 2011 (DE) 10 2011 003 295.9

(51) Int. Cl. E05B 85/20

(52) U.S. Cl. CPC E05B 85/20
USPC 292/194

(57) ABSTRACT

The invention relates to a lock for a door or hatch, having a locking mechanism that comprises a rotary latch and at least one locking pawl for latching the rotary latch. The rotary latch has a protruding blocking surface and a pocket-shaped recess or pocket adjoining the protruding blocking surface. The pocket-shaped recess extends arcuately from the protruding locking surface, whereby a “V”-shape is avoided. The arcuate shape prevents zones in which dust may accumulate to an increased extent. If dust is unable to accumulate to an increased extent, then there is correspondingly less dust available that may deposit between surfaces and cause creaking noises.

The invention relates to a lock for a door or hatch, having a locking mechanism that comprises a rotary latch and a locking pawl for latching the rotary latch. The rotary latch has a protruding blocking surface and a pocket-shaped recess adjoining the protruding blocking surface.

Such a lock serves to close openings in motor vehicles or vehicles at times, with the aid of doors or hatches. In the closed state of such a lock, the rotary latch grasps the locking bolt, normally of arcuate design, which in the case of a motor vehicle is usually attached to the body. If the rotary latch reaches a closed position by swiveling starting from an open position, the rotary latch is ultimately latched by means of the locking pawl. The rotary latch can then no longer be turned back in the direction of the open position, and the locking bolt can no longer leave the locking mechanism. To open, it is necessary to move the locking pawl out of the latching position.

In the closed position, the blocking surfaces of rotary latch and locking pawl are pressed against each other during latching. Both blocking surfaces are normally made of metal.

There are locks with two different latching positions of the rotary latch. The rotary latch can then first be latched in the so-called pre-latching position, and finally in the so-called main latching position by turning it further in the closing direction. It is true that in the pre-latching position a locking bolt can no longer leave the locking mechanism. But a corresponding door or hatch is not yet completely closed. Such a door or hatch is not completely closed until the rotary latch is turned further to the main latching position.

In the lifetime of a lock, in particular one utilized in motor vehicles, depending on the environmental conditions more or less thick coatings may form on the blocking surfaces of rotary latch and locking pawl, for example dust coatings from dust particles in the environment. Such coatings are unwanted. They increase the actuating forces to open the locking mechanism, and consequently diminish the comfort of operation. So if two blocking surfaces are pressed against each other for latching, and if dust has gotten between them, the opening forces increase with longer life.

From unpublished German patent application 10 2010 034 770, a lock is known having a locking mechanism in which the metal blocking surface of the rotary latch is in the form of an arcuate projection. Starting from this blocking surface, a pocket-shaped protrusion is formed in the rotary latch. Overall, the pocket-shaped protrusion is approximately V-shaped. In addition, on one side of the blocking surface the rotary latch of this lock has an overhang of the sheathing, which is normally made of plastic. With this overhang, the blocking surface of the locking pawl is brushed off in the manner of a scouring brush when entering into the “main latching” position of the lock, and consequently is freed of any soiling that may be present, such as dust.

It is the object of the present invention to prepare a lock that prevents an increase of opening forces with longer life, in particular due to soiling on the blocking surfaces, or where such an increase is at least reduced.

To fulfill the object, the lock includes the features of Claim 1. Advantageous forms result from the subordinate claims.

The lock for a door or hatch has a locking mechanism that comprises a rotary latch and at least one locking pawl for latching the rotary latch. The rotary latch has a protruding blocking surface and a pocket-shaped recess adjoining the latter. Starting from the protruding blocking surface, the pocket-shaped recess or pocket extends arcuately, whereby a “V”-shape is avoided. The arcuate shape prevents zones in which dust may accumulate to an increased extent. If dust is unable to accumulate to an increased extent, then there is correspondingly less dust available that may penetrate between blocking surfaces and be deposited, thus causing an increase in opening forces. Due to the arcuate transition from protruding blocking surface to the pocket, there is no corner in which dust could collect to an increased extent adjacent to the blocking surface.

It is true that an arcuate shape at the bottom of the V-shaped pocket is also known from German patent application DE 10 2010 034 770. However, this arc is separated from the protruding blocking surface by an angular transition.

Preferably, the arc does not include any rectilinear sections, so as to be able to keep the dimensions of the pocket small and the arc radii large. Through dust accumulation a coating builds up in the direction of the protruding blocking surface, which coating may pass over into the protruding blocking surface. A coating passing over into the protruding blocking surface causes an increase in opening forces. An accumulation of dust acting in this way, and an accompanying increase of opening forces, are avoided especially well with this embodiment, without having to provide a very large pocket for that purpose, which would result in an unwanted corresponding enlargement of the rotary latch. As long as the arc comprises relatively small radii, these are preferably located at a distance from the protruding blocking surface. In particular, the smallest zone with the smallest radius is located in the side wall of the pocket that lies opposite the protruding blocking surface.

The arc preferably extends over at least 100°, by preference over at least 140°, by further preference over at least 170°, and by particular preference over at least 175°. Preferably the arc does not extend over more than 190°. Only adjacent to such an arc can a rectilinear shape or an angular transition follow, which is however then located sufficiently far from the protruding blocking surface, at which opening forces may increase due to dust.

The radius of the arc is in particular not smaller than 1 mm, by particular preference not smaller than 1.5 mm, in order to prevent an approach to disadvantageous angular shapes. In the zone or in the side wall which abuts on the protruding blocking surface of the rotary latch, the radius of the arc is no smaller than 2 mm, preferably no smaller than 2.5 mm. The width of the opening of the pocket is preferably at least 4, mm, by particular preference at least 5 mm, for example approximately 5.5 mm. The pocket is preferably at least 2 mm deep, by particular preference at least 3 mm deep.

The opening of the pocket-shaped recess in the open and/or closed state of the rotary latch is preferably open downward, or at least obliquely downward. Particles can then fall out of the recess due to gravity. Thus, there are then no bowl-shaped zones in which dust could accumulate because of gravity alone.

In one embodiment of the invention, in addition to the formed pocket, the geometry of the rotary latch and locking pawl blocking surfaces is such that a pressure exerted on the locking pawl by the rotary latch does not produce any closing moment on the locking mechanism. In the case of a lock without a blockade lever which is able to block the locking pawl in the latched position, the geometry of said rotary latch and locking pawl is normally such that a closing moment can be introduced in the locking pawl by the rotary latch. In such a conventional lock, if the rotary latch exerts a pressure on the locking pawl in the main latching position, then a torque develops which attempts to turn the locking pawl in the direction of the latching position. Surprisingly, it has been found that with this embodiment, in which the rotary latch is not able to introduce any closing moment in the locking pawl, primarily in combination with the pocket according to the claims, it is possible to further improve the prevention of deposits on blocking surfaces which result in an increase in opening forces. The blocking surface of the locking pawl in this embodiment in particular has no regularly provided undercut, since otherwise the rotary latch would be able to introduce a closing moment in the locking pawl, whereby the locking pawl would be pressed in the direction of its latching position.

The invention may include one or more features of the locks mentioned at the beginning that are already known from the prior art, unless otherwise explicitly described as being according to the invention.

The invention will be explained in greater detail below on the basis of one exemplary embodiment. Unless otherwise explicitly described, the features evident from the exemplary embodiment may be combined with the claimed object individually or in any combination.

The figures show the following:

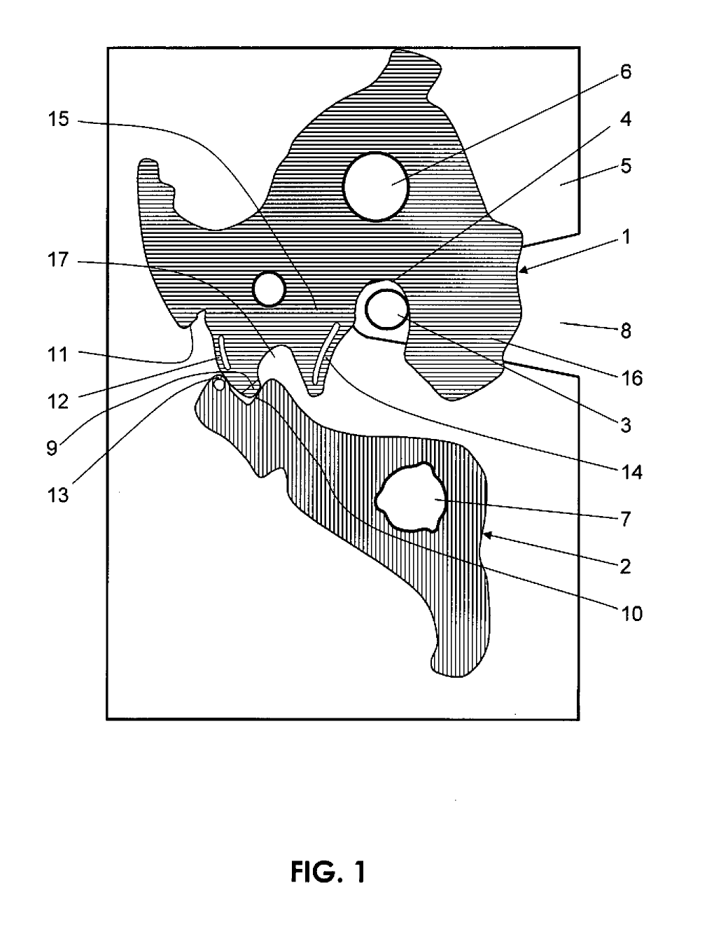

FIG. 1: the locking mechanism in the main latching position

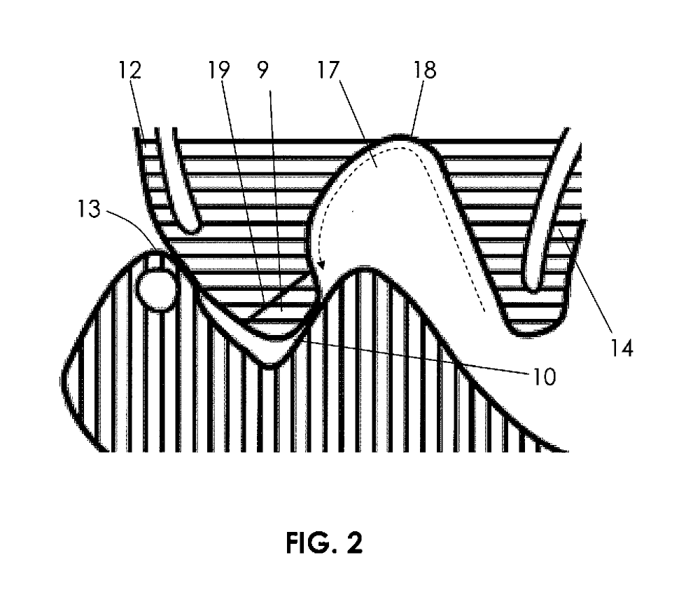

FIG. 2: enlarged depiction of the latching

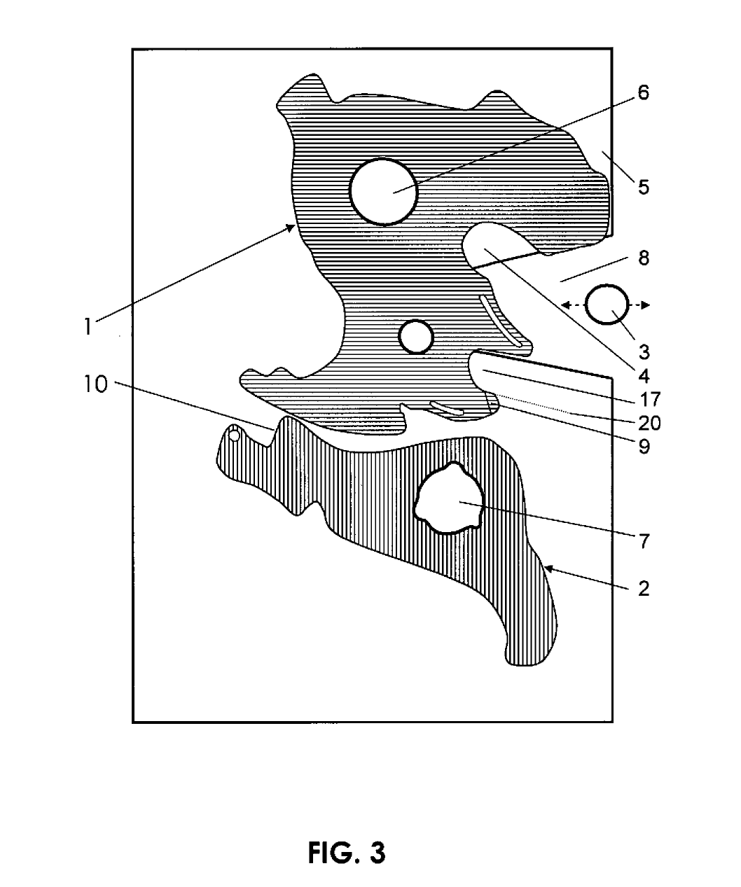

FIG. 3: the locking mechanism in the open position

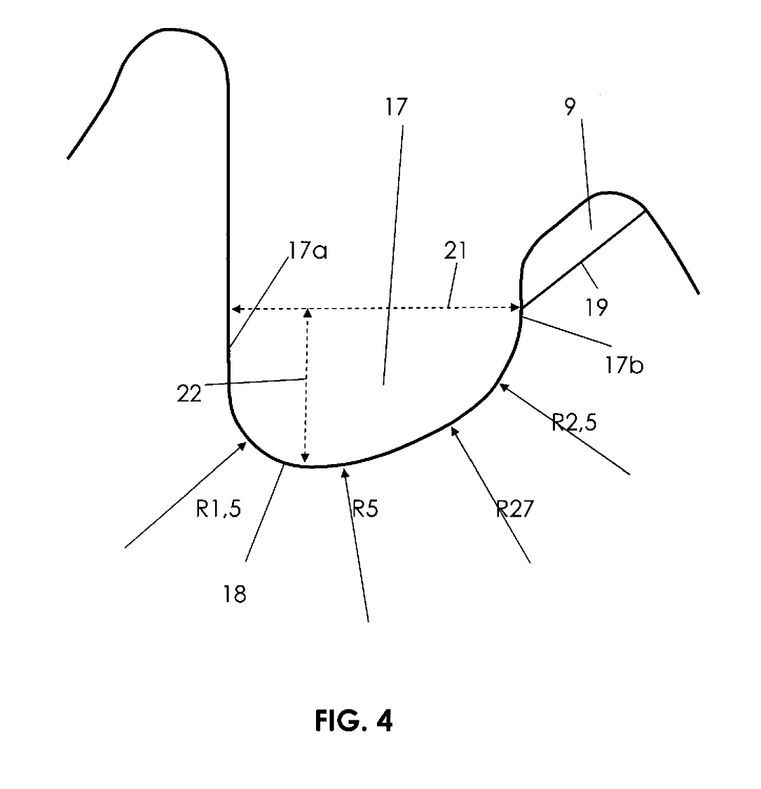

FIG. 4: detailed depiction of the pocket

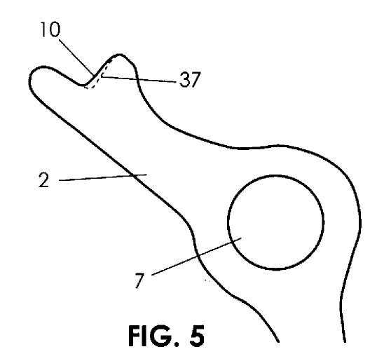

FIG. 5: locking pawl comparison

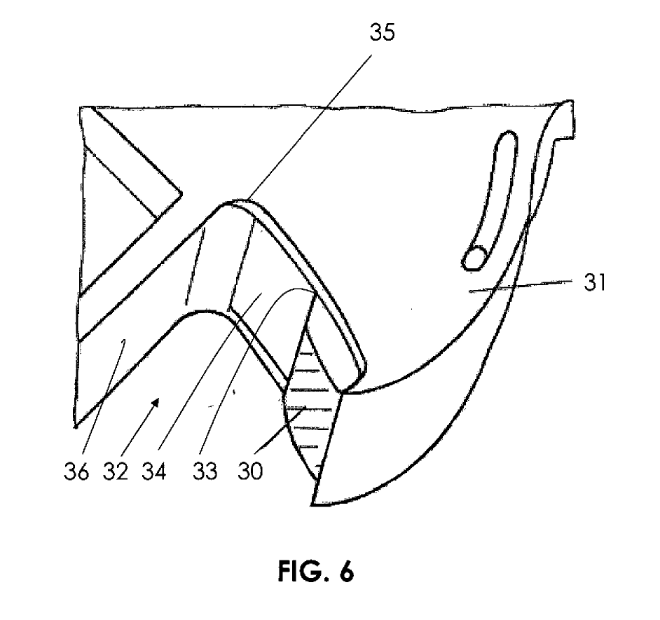

FIG. 6: segmental depiction of a rotary latch not according to the invention.

FIG. 1 shows a top view of a locking mechanism of a motor vehicle lock. The locking mechanism comprises a rotary latch 1 and a locking pawl 2. As depicted in the main latching position, the rotary latch 1, which is made at least partly, and preferably predominantly of metal, is latched by the locking pawl 2, which is made at least partly, and preferably predominantly, of metal. A locking bolt 3, which is attached to the body of the motor vehicle, is held in the inlet slit 4 of the rotary latch 1. The rotary latch 1 and the locking pawl 2 are rotatably attached to a lock plate 5. The rotary latch 1 may be rotated around its axis 6. The locking pawl 2 may be rotated around the axis 7. The lock plate 5—also known as the lock case—which is preferably made of metal, also has an inlet slit 8, so that the locking bolt 3 can be moved through it into and out of the lock. The rotary latch has a protruding blocking surface 9, which presses against a blocking surface 10 of the locking pawl 2 in the latched state in the main latched position. In the main latching position shown, the protruding blocking surface 9 of the rotary latch 1 exerts a pressure on the blocking surface 10 of the locking pawl 2. The two blocking surfaces 9, 10 of the rotary latch 1 and the locking pawl 2 are thus oriented neutrally relative to each other, and cause the exerted pressure to be unable to introduce any torque into the locking pawl 2.

The rotary latch 1 has a second latching surface 11 for latching the rotary latch in the pre-latching position. Between the latching surface 11 and the protruding blocking surface 9, the rotary latch includes a land 12 made of plastic, which is able to damp an impact of the locking pawl 2, which is pre-tensioned in the direction of the rotary latch, when the rotary latch 1 is rotated clockwise from the open position in the direction of the closed position. A comparably operating damping element in the form of an arcuate land 13 made of plastic is situated at a lever end of the locking pawl 2. On the one hand, this damping element acts as a stop, which limits the swiveling of the locking pawl 2 in the main latching position. At the same time, the arcuate land 13 damps an impact when the locking pawl 2 is moved into the main latching position, for example due to a correspondingly pre-tensioned spring.

A land 14 made of plastic, which acts as a damping element, damps an impact of locking bolt 3 on the catcher arm 15 of the rotary latch 1 during a closing motion. In the depicted main latching position, the load arm 15 prevents the locking bolt 3 from being able to leave the locking mechanism.

The rotary latch 1 and the locking pawl 2 are made of metal, which is partially sheathed in a covering of plastic for the purpose of damping and minimizing friction losses.

In FIG. 1, the locking mechanism is shown in the installed state in a door of a motor vehicle. The opening of the inlet slit 4 of the rotary latch 1 then faces downward. The locking pawl 2 is situated beneath the rotary latch 1.

In FIG. 2, the area from FIG. 1 that accomplishes the latching is shown enlarged. Adjacent to the protruding blocking surface 9 is a pocket-shaped zone 17. The pocket-shaped zone 17 is formed by an arcuate contour 18. This is a 180° arc, whose contour is completely free of corners or vertexes in which dust would be able to become deposited to a significant extent. The transition to the lateral contour zone of the protruding blocking surface 9, which is in contact with the latching surface 10 of the locking pawl, is also free of corners or vertexes. The arcuate contour shape 18 causes an air draft or gust of wind to be able to pass undisturbed completely over the arcuate lateral wall zone 18 as indicated by the dashed arrow, so that dust present on the wall surface 18 can be picked up and transported away reliably. There are no corner zones which could be bypassed by a wind gust, so that dust would remain to a greater extent in such corner zones. Dust which gets into the pocket 17 and adheres to the wall area 12 is then also regularly blown out again, and especially when rotary latch 1 is not latched in the main latching position. This prevents a greater quantity of dust from accumulating in the pocket zone 17, which can get between the contact surfaces of rotary latch and locking pawl and then cause an increased opening force. This relates in particular to the contact zone between the latching surface 10 of the locking pawl and the protruding blocking surface 9, which can be kept practically free of dust by the arcuate shape, as experiments have shown. It is expedient for the blocking surface 9 to be free of plastic, so that a plastic sheathing of the rotary latch for example extends only to the boundary 19.

It has been found that avoiding an increase in opening forces with longer life is more successful if the size of the pocket 17 is increased. Since on the other hand a lock should be small, the pocket cannot be designed with unlimited size. Against this background, it has proven to be expedient to dimension the pocket as follows: The width of the opening of the pocket 17 should be at least 4 mm, preferably at least 5 mm. The width of the opening of the pocket should be no more than 7 mm, preferably no more than 6 mm. The maximum depth of the pocket 17 should be no more than 4.5 mm, preferably no more than 3.5 mm. The minimum depth of the pocket 17 should be at least 1.5 mm, preferably at least 2.5 mm.

In FIG. 3, the locking mechanism is shown in the open position in the installed state. In this position, the locking bolt 3 can be moved both into the inlet slit 4 of the rotary latch 1 and out of the lock, as indicated by the double arrow. The opening of the pocket 17 is directed first of all toward the side, but nevertheless slightly obliquely downward, as illustrated by the dotted line 20. The opening of the pocket is thus directed so that non-adhering particles would be able to roll out of the pocket 17 due to gravity alone. In the depicted open position, air eddying in the pocket 17 ensures that dust is regularly transported out of the pocket 17, without the threat of dust remaining in corner zones. If a door or hatch is opened or closed, the movement of the door provides for the desired eddying of air in the pocket 17.

FIG. 4 shows a detailed depiction of pocket 17. Pocket 17 is depicted so that the two lateral wall zones 17a and 17b of the pocket run essentially vertically in FIG. 4. The width of the opening of the pocket is now indicated by the horizontal dashed line which ends at one end at the sheathing boundary 19. The pocket zone is beneath this horizontal dashed line 21. The maximum depth of the pocket is represented by the vertical dashed line 22. The width 21 is 5.5 mm. The depth 22, i.e., the deepest place in the pocket 17, is 3.1 mm. On the one hand, these values adequately prevent dust from reaching the protruding blocking surface 9. On the other hand, these values are chosen so that the pocket 9 does not contribute to an appreciable enlargement of the rotary latch 1.

In addition, the radii of the pocket 17 are clarified in FIG. 4. First of all, a radius named R2.5 which abuts on the protruding metal blocking surface 9, is 2.5 mm. Also shown is a radius R27 of 27 mm, which abuts on the radius R2,5. Adjoining this is a radius R5, which is 5 mm. Seen from the protruding metal blocking surface 9 on the other side of the pocket in the area of the side wall 17a, there is then a relatively small radius R1.5 with a radius of 1.5 mm.

FIG. 5 shows the non-undercut blocking surface 10, kept neutral in regard to torque transmission, in comparison to a normal undercut blocking surface 37 (dashed line). If the locking pawl 2 has an undercut blocking surface 37, then a closing moment is introduced into the locking pawl when the blocking surface of the rotary latch exerts pressure on the blocking surface 10 of the locking pawl 2. For the especially effective prevention of deposits that result in increased opening forces, locking pawl 2 preferably has the non-undercut blocking surface 10 shown in FIG. 5.

FIG. 6 shows a protruding latching surface 30 of a rotary latch 31 not according to the invention, which serves for latching in the main latching position when high forces occur. Adjacent to the protruding latching surface 30 is a pocket-shaped protrusion 32. The transition 33 from the protruding latching surface 30 to the pocket 32 is angular in shape. Seen from the protruding latching surface 30, starting from the angular transition 33 the lateral contour 34 of the pocket 32 first runs in a straight line, until an approximately 100° arc 35 with a relatively small diameter is reached. Because of this relatively small diameter, this arc 35 is likewise similar again to an angular transition. Next, there is again a rectilinear contour zone 36, so that the pocket is similar on the whole to a “V”.

### REFERENCE LABELS

1: rotary latch
2: locking pawl
3: locking bolt
4: inlet slit of the rotary latch
5: lock plate, lock case
6: rotary latch axis
7: locking pawl axis
8: lock case inlet slit
9: protruding blocking surface for main latching
10: latching surface of locking pawl
11: blocking surface of rotary latch for pre-latching
12: land
13: land
14: land
15: catcher arm of the rotary latch
16: load arm
17: pocket-shaped zone or recess; pocket
17a lateral wall zone of the pocket
17b lateral wall zone of the pocket
18: arcuate contour; arc
19: sheathing boundary
20: oblique course downward
21: width of the opening of the pocket
22: depth of the pocket
30: protruding latching surface
31: rotary latch
32: pocket-shaped protrusion
33: angular transition
34: lateral contour
35: arc
36: lateral contour zone
37: undercut blocking surface

1. A lock for a door or hatch, having a locking mechanism that comprises a rotary latch and a locking pawl for latching the rotary latch, wherein the rotary latch includes a protruding blocking surface and an arcuate pocket-shaped recess abutting on the protruding blocking surface,
wherein the transition from the protruding blocking surface to the recess is arcuate in shape.

2. The lock according to claim 1, wherein the arcuate shape includes no rectilinear sections.

3. The lock according to claim 1, wherein there is at least one 140° arc, preferably at least one 170° arc, by particular preference at least one 180° arc.

4. The lock according to claim 1, wherein the arc includes no rectilinear shapes.

5. The lock according to claim 1, wherein the transition of the protruding blocking surface to the arcuate shape includes no angular shapes.

6. The lock according to claim 1, wherein the radius of the arc is no smaller than 1.3 mm.

7. The lock according to claim 1, wherein a plastic sheathing extends as far as the protruding blocking surface.

8. The lock according to claim 1, wherein in the installed state of the lock the opening of the pocket-shaped recess in the open and/or closed state of the rotary latch is open downward or obliquely downward, in particular in such a way that dust can fall out of the recess due to gravity.

9. The lock according to claim 1, wherein in the installed state the latching pawl is beneath the rotary latch.

10. The lock according to claim 1, wherein the geometries of rotary latch and locking pawl are such that the rotary latch is unable to introduce any torque into the locking pawl, and the blocking surface of the locking pawl in particular has no undercut.

11. A motor vehicle door having a lock according to claim 1.
